(19) United States
(12) Patent Application Publication
(10) Pub. No.: US 2008/0217307 A1
(43) Pub. Date: Sep. 11, 2008

(54) Method for Assembling Metal Sheets Which are Coated with a Protection Layer by Laser Transparent Welding and are Interspaced by Protuberances

(75) Inventors: Bertrand Dauvel, Vernouillet (FR); Marion Joly, Versailles (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S, Boulogne Billancourt (FR)

(21) Appl. No.: 11/911,729

(22) PCT Filed: Mar. 23, 2006
(86) PCT No.: PCT/FR2006/050255

§ 371 Date: May 9, 2008

(30) Foreign Application Priority Data
Apr. 18, 2005 (FR) 0503838

(51) Int. Cl. B23K 26/20

(52) U.S. Cl. 219/121.64

(57) ABSTRACT

A method for assembling at least two sheets by laser transparent welding, wherein at least one sheet is coated with a metal protection layer. The method produces punctual deformations on the side of at least one metal sheet, which is to be welded, along a predetermined trajectory thereby forming protuberances; superimposes the metal sheets so that the protuberances project towards the other metal sheet to be welded; holds the sheets tightly against one another by a clamp located on both sides of the predetermined trajectory such that the sheets are in contact with each other at the protuberance; and welds the assembly of metal sheets by a laser beam transparently applied in a discontinuous manner along a predetermined length at each deformation.

The invention relates to a method of joining sheets covered with a protective layer by laser through-welding.

Laser through-welding methods require control of the way the sheets to be welded are gripped together so as to ensure melting and therefore a weld. Moreover, during laser through-welding of sheets covered with a protective layer, for example a zinc layer, the temperature reached in order to melt the sheets and fuse them together causes the protective layers to be vaporized. If the sheets are in close contact at the point of the weld, the gases thus formed can escape only via the weld pool, thus degrading the quality of the weld.

Several solutions exist for evacuating the vapors coming from the evaporated layers.

In document DE 10 042 538, a sheet placed between two other sheets has an irregular surface so that, when it is in contact with the other sheets, cavities are created via which the gases formed can escape. However, this solution requires a special treatment of the surfaces of the sheet so as to form the rugosities.

In document DE 10 053 789, a space is created between the two sheets to be joined together, by depositing a structure between the sheets, for example a flexible film having orifices. This solution requires the manufacture and the deposition of another material, thereby proving to be lengthy and expensive.

In other methods, such as the one described in document EP 337 182, one of the sheets to be joined together is deformed by stamping over its entire length. This longitudinal deformation makes it possible both to evacuate the gases formed and to guide a continuos laser beam. However, this solution requires subjecting the sheet to a substantial impact, unfavorable to the mechanical strength of the sheet. Moreover, the use of a continuous laser beam proves to be expensive.

Another type of laser through-welding method is described in document DE 44 43 826, during which the sheets to be joined together are kept a certain distance apart. The problem of evacuating the possible gases formed by the protective layers then does not arise. The gap between the sheets requires discrete stamping of one of the sheets so as to bring the sheets together and to allow them to be welded. However, this method requires the two sheets to be held apart by a predetermined distance during the stamping and welding operations.

The object of the invention is to alleviate these drawbacks by proposing a joining method using laser through-welding that allows evacuation of the gases formed by the vaporization of the protective layers on the sheets, which is simple to implement and is inexpensive. The method according to the invention also has the advantage of not requiring large deformations of the sheets so that their mechanical strength is not, or hardly, affected.

For this purpose, the subject of the invention is a method of joining at least two sheets by laser through-welding, at least one of the sheets being covered with a metal protective layer, characterized in that it comprises the steps consisting in:
producing, on at least one of the sheets to be welded, discrete deformations placed along a predetermined path, so as to form protrusions on one face of the sheet thus deformed;
superposing the sheets to be welded so that the protrusions of the deformed sheet project toward another sheet to be welded, the deformed sheet being covered with a metal protective layer;
keeping the sheets to be welded clamped together by gripping means placed on either side of the predetermined path, so that the sheets are in contact around the discrete protrusions; and
welding the sheets together by means of a laser beam by laser-through welding discontinuously over a predetermined length around each discrete deformation.

In one embodiment, the sheet in contact with the protrusions of the deformed sheet is also covered with a metal protective layer.

In another embodiment, only the sheet in contact with the protrusions of the deformed sheet is covered with a metal protective layer.

In all cases, while the gripping means are clamping the sheets together, cavities form between the sheets to be welded around the protrusions. These cavities are sufficient to receive and/or discharge the gases formed by the vaporization of the protective layers without degrading the quality of the weld. In addition, applying the laser beam discontinuously, i.e. only around the protrusions, makes it possible to reduce the costs compared to methods using a continuous laser beam.

Preferably, discrete deformations forming spherical protrusions are produced. Such spherical impressions are easy to produce, for example by stamping, and may be easily reproduced in identical manner, thereby improving the reproducibility of the welding and its automation.

Advantageously, during the welding step the laser beam is applied along a linear segment of predetermined length around each protrusion.

Preferably, each segment passes through, or nearby, the point of contact between the sheets.

More particularly, each segment is substantially centered on the point of contact between the sheets.

According to particular embodiments, the segments are substantially perpendicular to the path of the protrusions or may lie substantially along the path of the protrusions.

Advantageously, the gripping means are located at a same predetermined distance on either side of the path of the protrusions.

The invention will now be described with reference to the appended nonlimiting drawings in which:

FIG. 1 is a sectional view of two sheets welded together by one embodiment of the method according to the invention;

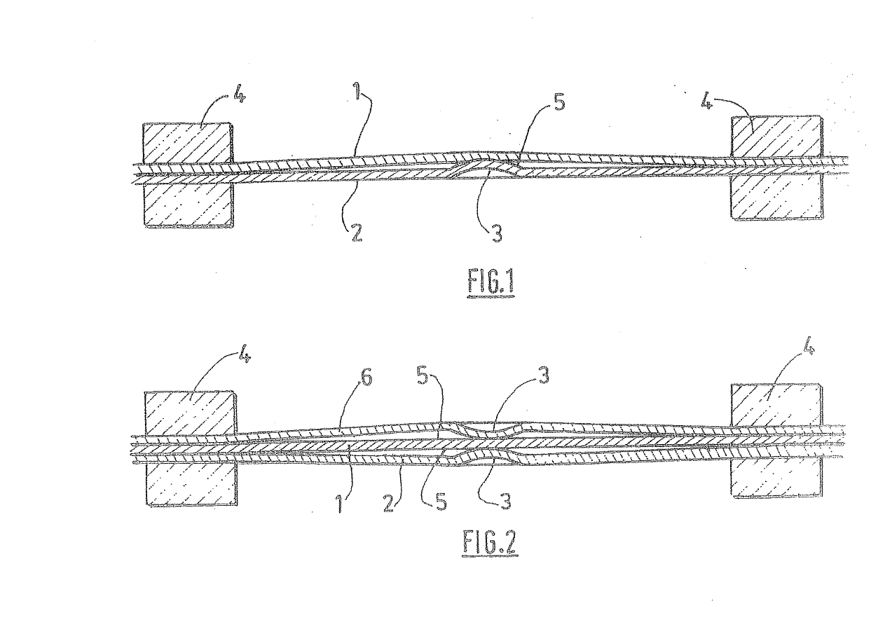

FIG. 2 is a sectional view of three sheets welded together by an alternative embodiment of the method according to the invention;

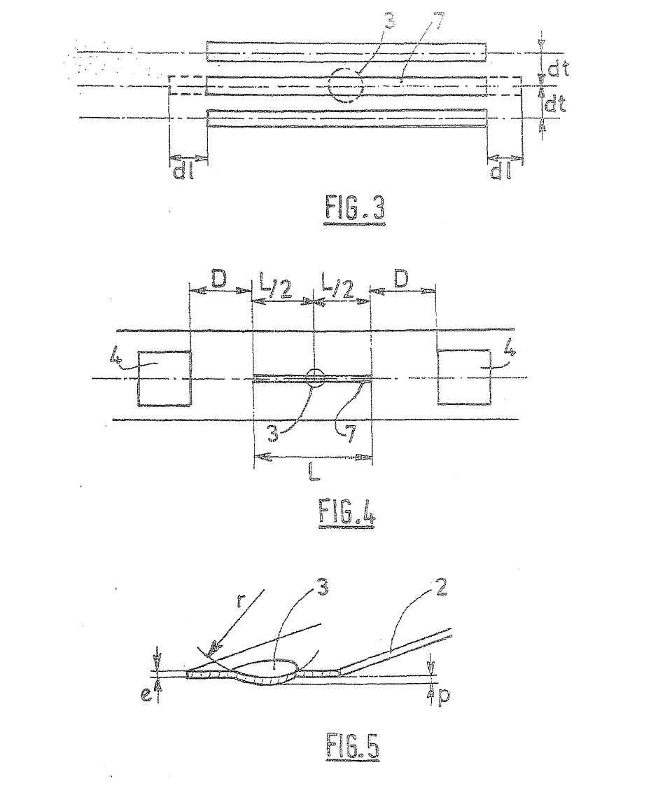

FIG. 3 is a plan view of the joined sheets, showing a laser beam segment in relation to a protrusion of a deformed sheet;

FIG. 4 is a plan view showing a protrusion, the means for gripping the sheets, and a protrusion of a deformed sheet; and

FIG. 5 shows a perspective view of a spherical protrusion of radius r formed on a sheet of thickness e.

FIG. 1 shows two metal sheets 1 and 2 to be joined together by laser through-welding. One of the sheets, or both of them, is covered with a metal protective layer such as a zinc layer.

Discrete deformations are produced on one of the sheets 2, for example by stamping, so as to form protrusions 3 all projecting from the same face of the sheet 2. These deformations are produced along a predetermined path. This path corresponds to the path along which it is desired to weld the two sheets together.

Preferably, the deformations are produced so as to form spherical protrusions (FIG. 5), in order for them to be able to be easily reproduced. Of course, other protrusion shapes may also be produced.

To join the two sheets together, they are superposed so that the protrusions 3 of the deformed sheet 2 project toward the other sheet 1.

The two sheets are held clamped together by gripping means 4 so that the deformed sheet 2 is in contact with the other sheet 1 around each protrusion 3. For this purpose, the gripping means 4 are preferably placed on either side of each protrusion 3. It is possible for the gripping means to extend in a continuous manner over the entire length of the path of the protrusions, or else the gripping means may be placed at discrete points around each protrusion.

Owing to the presence of a protrusion 3, when the sheets 1, 2 are clamped together, a cavity 5 is created around the perimeter of the protrusion. This cavity 5 can receive the gases formed during vaporization of the metal protective layers on the opposed faces of the sheets 1, 2.

Similarly, FIG. 2 shows the joining of three superposed metal sheets 1, 2 and 6. In this case, the two outer sheets 2 and 6 are deformed so as to have protrusions 3. These protrusions 3 are preferably substantially identical and produced along substantially identical paths. The sheets 1, 2, 6 are then superposed so that the paths along which the protrusions 3 of each deformed sheet lie are superposed, as shown in FIG. 2.

Likewise, as in the case of joining two sheets together, the three sheets are kept superposed and clamped together by gripping means 4, so that the protrusions 3 of the deformed sheets 2 and 6 project toward the central sheet 1, the protrusions 3 being superposed. Cavities 5 are then formed around each protrusion, on either side of the central sheet 1, allowing the gases formed by the vaporization of the metal protective layers on the opposed faces of the sheets to be received.

In both cases, when the sheets are kept clamped together by the gripping means 4, the weld is produced by means of a laser beam (not shown) by discontinuous through-welding around each protrusion 3.

Preferably, this laser beam is applied along a linear segment 7, shown in FIGS. 3 and 4.

In the examples shown, this segment 7 lies substantially perpendicular to the path of the protrusions 3 and is in alignment with the gripping means 4 (FIG. 4).

Preferably, the segment 9 passes through or nearby each protrusion 3. Thus, it may be slightly offset transversely by an amount dt or longitudinally by an amount dl (FIG. 3) without impairing the quality of the weld. Preferably, it is centered on the protrusion 3.

The following parameters are defined: L, length of the segment; D, the distance between each end of the segment and the corresponding gripping means (FIG. 4); p, the height of the protrusion (FIG. 5).

The desired dimensions of the cavity 5 (corresponding to the gap between the joined sheets), depending on the length of the segment 7, are obtained by varying the distance (D+L/2) between the gripping means 4 and the protrusion in question and by varying the height p of the protrusion.

By producing substantially identical protrusions along the welding path, it is possible to automate the welding, by making it easier to locate the position of each protrusion before applying the laser beam. The laser beam can therefore be applied along a segment, the position and the dimensions of which are determined relative to the position of each protrusion.

The method according to the invention may be used in the automotive field. For example, it may be applied to the welding of interior and exterior door panels of a motor vehicle.

Each panel includes a rebate at which it is joined to the other panel using the method of the invention.

The panels are joined together in the following manner:
protrusions are produced on one of the rebates;
the door panels are then joined together and held clamped by the gripping means in a predetermined position; and
at each protrusion, the laser beam is then applied along a segment of length L aligned with the gripping means and passing through, or nearby, the protrusion in question. This step is repeated for each protrusion.

1-7. (canceled)

8. A method of joining at least two sheets by laser through-welding, at least one of the sheets being covered with a metal protective layer, the method comprising:
producing, on at least one of the sheets to be welded, discrete deformations placed along a predetermined path, so as to form protrusions on one face of the sheet thus deformed;
superposing the sheets to be welded so that the protrusions of the deformed sheet project toward another sheet to be welded, the deformed sheet being covered with a metal layer;
keeping the sheets to be welded clamped together by a gripping device placed on either side of the predetermined path, so that the sheets are in contact around the discrete protrusions; and
welding the sheets together by a laser beam by laser-through welding discontinuously over a predetermined length around each discrete deformation,
wherein the welding laser beam is applied along a linear segment of predetermined length around each protrusion, the segment being substantially perpendicular to the path of the protrusions.

9. The joining method as claimed in claim 8, in which the sheet in contact with the protrusions of the deformed sheet is also covered with a metal protective layer.

10. The joining method as claimed in claim 8, in which only the sheet in contact with the protrusions of the deformed sheet is covered with a metal protective layer.

11. The joining method as claimed in claim 8, in which discrete deformations forming spherical protrusions are produced.

12. The joining method as claimed in claim 8, in which each segment passes through, or nearby, the point of contact between the sheets.

13. The joining method as claimed in claim 8, in which each segment is substantially centered on the point of contact between the sheets.

14. The joining method as claimed in claim 8, in which portions of the gripping device are located at a same predetermined distance on either side of the predetermined path of the protrusions.
